(19) United States
(12) Patent Application Publication
(10) Pub. No.: US 2025/0038164 A1
(43) Pub. Date: Jan. 30, 2025

(54) Method of Manufacturing Electrode for Secondary Battery Using Insulating Composition Including Aqueous Binder Substituted with Non-Aqueous Solvent

(71) Applicant: LG Energy Solution, Ltd., Seoul (KR)

(72) Inventors: Seong Keun Jang, Daejeon (KR); Sung Chul Park, Daejeon (KR); Sang A. Choi, Daejeon (KR); Sung Soo Yoon, Daejeon (KR)

(73) Assignee: LG Energy Solution, Ltd., Seoul (KR)

(21) Appl. No.: 18/917,529

(22) Filed: Oct. 16, 2024

Related U.S. Application Data
(63) Continuation of application No. 18/028,406, filed on Mar. 24, 2023.

(30) Foreign Application Priority Data
Aug. 27, 2021 (KR) 10-2021-0113557
Jul. 22, 2022 (KR) 10-2022-0090828

(51) Int. Cl. H01M 4/04; H01M 4/62; H01M 10/052; H01M 10/0569

(52) U.S. Cl. CPC H01M 4/0416; H01M 4/623; H01M 10/0569; H01M 10/052; H01M 2300/0042

(57) ABSTRACT

The present technology relates to a method of manufacturing an electrode for a secondary battery. Aince an electrode is manufactured using an insulating composition including an aqueous binder dispersed in a non-aqueous solvent, the wet adhesion of an insulating layer can be increased, and the gelation between an electrode slurry and the insulating composition, which is caused by using different types of binders, can also be prevented.

### CROSS-REFERENCE TO RELATED APPLICATIONS

The present application is a continuation of application Ser. No. 18/028,406, filed on Mar. 24, 2023, which is a national phase entry under 35 U.S.C. § 371 of International Application No. PCT/KR2022/011304, filed on Aug. 1, 2022, which claims priority from Korean Patent Application No. 10-2021-0113557, filed on Aug. 27, 2021, and Korean Patent Application No. 10-2022-0090828, filed on Jul. 22, 2022, the disclosures of which are incorporated herein by reference.

### BACKGROUND

As the technology for mobile devices is developed and the demand for mobile devices increases, the demand for secondary batteries as a power source is rapidly increasing, and accordingly, many studies have been conducted on batteries which can meet various needs.

Typically, in terms of a battery shape, there is a high demand for thin prismatic and pouch-type batteries that can be applied to products such as mobile phones and the like. Also, in terms of a material, there is a high demand for lithium secondary batteries such as lithium cobalt polymer batteries excellent in energy density, discharge voltage, and safety.

One of the main research tasks related to the secondary batteries is to enhance safety. Battery safety-related accidents are mainly caused by the arrival of an abnormal high temperature state due to a short circuit between a positive electrode and a negative electrode. That is, in normal situations, since a separator is provided between a positive electrode and a negative electrode, electrical insulation is maintained. On the other hand, in abnormal situations in which a battery is excessively charged or discharged, the dendritic growth of an electrode material or an internal short circuit caused by foreign substances occurs. Some examples of foreign substances may be sharp objects such as nails and the like, which may penetrate a battery. Another example of abnormal situations may be that a battery is excessively deformed by an external force, and existing separators have limitations on maintaining electrical insulation.

As a supplementary means for preventing an internal short circuit of a battery, a method of attaching an insulating tape or applying an insulating liquid to the boundary line between the non-coated part and coated part of an electrode to form an insulating layer has been proposed. For example, there is a method of applying an insulating binder to the boundary line between the non-coated part and coated part of a positive electrode or applying an insulating liquid in which a mixture of the binder and inorganic particles is dispersed in a solvent to form an insulating layer.

Conventionally, non-aqueous binders (e.g., PVDF) were used in an insulating layer of a positive electrode. However, the resulting insulating layer exhibits degradation in adhesion (hereinafter, referred to as wet adhesion) while being immersed in a liquid electrolyte and thus does not block the migration of lithium ions in the overlay region of an electrode to cause capacity expression. Accordingly, research on the use of aqueous binders such as styrene-butadiene rubber in an insulating layer of a positive electrode has been conducted. However, to perform coating using aqueous binders such as styrene-butadiene rubber, water needs to be used as a solvent. Accordingly, there are problems in that it is difficult to apply water as a solvent to a positive electrode, which is vulnerable to moisture, and the gelation of binders between an insulating composition and a positive electrode slurry occurs.

### Technical Problem

The present disclosure is directed to providing a method of manufacturing an electrode for a secondary battery using an insulating composition including an aqueous binder dispersed in a non-aqueous solvent.

### Technical Solution

One aspect of the present disclosure provides a method of manufacturing an electrode for a secondary battery, which includes: applying an electrode slurry including an electrode active material, a conductive material, and a non-aqueous binder onto one surface or both surfaces of a current collector; applying an insulating composition including an aqueous binder dispersed in a non-aqueous solvent so that the insulating composition covers from a portion of the non-coated part of the current collector to a portion of the electrode slurry applied onto the current collector; and drying the electrode slurry and insulating composition applied onto the current collector. Also, the electrode slurry and the insulating composition include the same or same type of a non-aqueous organic solvent.

In an embodiment, the application of an electrode slurry and the application of an insulating composition may satisfy the following Expression 1.

$$0 \leq T 2 - T 1 \leq 100 ( sec ) \qquad [ Expression 1 ]$$

In Expression 1,

T1 refers to the time (sec) at which an electrode slurry is discharged onto a current collector from a slot-die coater in the application of an electrode slurry, and

T2 refers to the time (sec) at which an insulating composition is discharged onto a current collector from a slot-die coater in the application of an insulating composition.

In this case, the application of an insulating composition may be performed in a state in which the electrode slurry applied onto the current collector is not dried.

The non-aqueous organic solvent may be one or more selected from the group consisting of N-methyl-pyrrolidone (NMP), dimethyl formamide (DMF) and dimethyl acetamide (DMAc), dimethyl sulfoxide (DMSO), ethylene carbonate (EC), diethyl carbonate (DEC), ethyl methyl carbonate (EMC), dimethyl carbonate (DMC), propylene carbonate (PC), dipropyl carbonate (DPC), butylene carbonate (BC), methyl propyl carbonate (MPC), ethyl propyl carbonate (EPC), acetonitrile, dimethoxyethane, tetrahydrofuran (THF), γ-butyrolactone, methyl alcohol, ethyl alcohol, and isopropyl alcohol.

In addition, the insulating composition may further include inorganic particles.

Specifically, the inorganic particles may be one or more selected from the group consisting of AlOOH, Al₂O₃, γ-AlOOH, Al(OH)₃, Mg(OH)₂, Ti(OH)₄, MgO, CaO, Cr₂O₃, MnO₂, Fe₂O₃, Co₃O₄, NiO, ZrO₂, BaTiO₃, SnO₂, CeO₂, Y₂O₃, SiO₂, silicon carbide (SIC), and boron nitride (BN).

In this case, a weight ratio of the inorganic particle and aqueous binder in the insulating composition may range from 1:99 to 95:5.

In addition, the non-aqueous binder may be one or more selected from the group consisting of polyvinylidene fluoride (PVDF), polyvinylidene fluoride-co-hexafluoropropylene (PVDF-co-HFP), polyethylene oxide (PEO), polyacrylic acid (PAA), polyimide (PI), polyamideimide (PAI), and a polyimide-polyamideimide copolymer (PI-PAI).

Additionally, the aqueous binder may be one or more selected from the group consisting of styrene-butadiene rubber, acrylate styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene-propylene copolymer, polyethylene oxide, polyvinylpyrrolidone, polyepichlorohydrin, polyphosphazene, polyacrylonitrile, polystyrene, an ethylene-propylene-diene copolymer, polyvinylpyridine, chlorosulphonated polyethylene, latex, polyester resin, an acrylic resin, phenolic resin, an epoxy resin, polyvinyl alcohol, hydroxypropyl methylcellulose, hydroxypropyl cellulose, and diacetyl cellulose.

The insulating composition may include: an aqueous binder dispersed in a non-aqueous solvent; and inorganic particles dispersed in the aqueous binder matrix, which is dispersed in a non-aqueous solvent. Specifically, a weight ratio of the inorganic particle and the aqueous binder may range from 1:99 to 95:5. Also, the insulating composition may have a viscosity at 25° C. of 50 cP to 50,000 cP.

The non-aqueous organic solvent may be N-methyl-pyrrolidone (NMP), and the aqueous binder may be styrene-butadiene rubber (SBR).

Furthermore, the drying of the electrode slurry and insulating composition applied onto the current collector may be performed at an average temperature of 50° C. to 300° C.

In addition, the application of an electrode slurry and the application of an insulating composition may be performed using a slot-die coater. The application of an electrode slurry and the application of an insulating composition may be performed using a single die coater including two slots. The die coater may include an electrode slurry discharge slot and an insulating composition discharge slot.

The application of an electrode slurry and the application of an insulating composition may be performed using two separate die coaters. The application of an insulating composition may be performed before an electrode slurry discharged in the application of an electrode slurry is dried.

### Advantageous Effects

According to a method of manufacturing an electrode for a secondary battery of the present disclosure, an aqueous binder having excellent wet adhesion is used in the formation of an insulating layer, and the gelation between an electrode slurry and an insulating composition, which is caused by using different types of binders, can be prevented.

### BRIEF DESCRIPTION OF DRAWINGS

FIG. 1 is a schematic diagram showing the migration of lithium ions in an overlay region of an electrode.

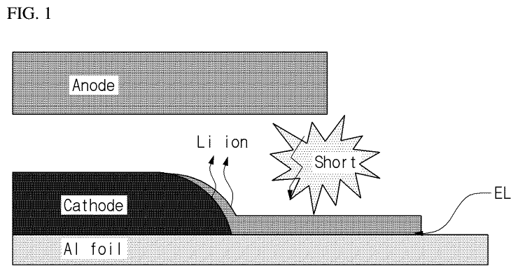

FIG. 2 is a flow chart of a method of manufacturing an electrode for a secondary battery according to the present disclosure.

FIG. 3 is a photographic image showing results before and after drying when an electrode slurry and an insulating composition prepared in Comparative Example 1 are simultaneously applied.

FIG. 4 is a photographic image showing results before and after drying when an electrode slurry and an insulating composition prepared in Example 1 are simultaneously applied.

FIG. 5 shows results of measuring the wet adhesion of insulating layers of examples and comparative examples.

FIG. 6 is a graph obtained by measuring discharge capacity to evaluate a capacity expression of battery cells of Examples 4 to 6 (room-temperature discharge characteristics).

FIG. 7 is a graph obtained by measuring discharge capacity to evaluate the capacity expression of the battery cells of Examples 4 to 6 (high-temperature discharge characteristics).

### DETAILED DESCRIPTION

As the present disclosure allows for various changes and a variety of aspects, particular aspects will be described in detail in the detailed description.

However, this is not intended to limit the present disclosure to specific aspects, and it should be understood that all changes, equivalents, or substitutes within the spirit and technical scope of the present disclosure are included in the present disclosure.

In the present disclosure, it should be understood that the term “include(s)” or “have (has)” is merely intended to indicate the presence of features, numbers, steps, operations, components, parts, or combinations thereof, and not intended to preclude the possibility of the presence of addition of one or more other features, numbers, steps, operations, components, parts, or combinations thereof.

In addition, in the present disclosure, when a portion of a layer, film, region, plate, or the like is referred to as being “on” another portion, this includes not only the case where the portion is “directly on” but also the case where there is another portion interposed therebetween. Conversely, when a portion of a layer, film, region, plate, or the like is referred to as being “under” another portion, this includes not only the case where the portion is “directly under” but also the case where there is another portion interposed therebetween. Also, herein, what is referred to as being disposed “on” may include being disposed not only on an upper part but also on a lower part.

As used herein, an “insulating layer” refers to an insulating member formed by applying an aqueous binder dispersed in a non-aqueous solvent from at least a portion of the non-coated part of an electrode current collector to at least a portion of an electrode mixture layer and drying.

As used herein, “wet adhesion” refers to the adhesion of an insulating layer as measured in an immersed state in a liquid electrolyte. More specifically, the wet adhesion may be measured by immersing a metal specimen including an insulating layer formed therein in a liquid electrolyte, applying ultrasonic waves, and then determining whether the insulating layer is swelled or detached.

As used herein, a “metal specimen” is a space where an insulating layer is formed and may refer to a metal current collector used in manufacture of an electrode, specifically, a metal current collector blanked to have a predetermined width and a predetermined length. For example, the metal specimen may be aluminum, copper, or an aluminum alloy.

As used herein, an “overlay region” may refer to a region where an insulating layer is formed in an electrode. More specifically, in an electrode in which a mixture layer is formed, the insulating layer covers from at least a portion of a non-coated part to at least a portion of the mixture layer, and a region where an insulating layer is formed on the mixture layer is referred to as an overlay region.

Hereinafter, the present disclosure will be described in further detail.

### Method of Manufacturing Electrode for Secondary Battery

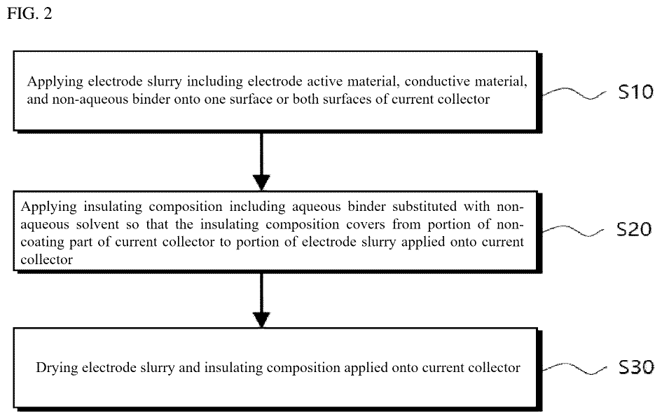

FIG. 2 is a flow chart of a method of manufacturing an electrode for a secondary battery according to the present disclosure.

Referring to FIG. 2, one aspect of the present disclosure provides a method of manufacturing an electrode for a secondary battery, which includes:
applying an electrode slurry including an electrode active material, a conductive material, and a non-aqueous binder onto one surface or both surfaces of a current collector (S10);
applying an insulating composition including an aqueous binder so that the insulating composition covers from at least a portion of the non-coated part of the current collector to a portion of the electrode slurry applied onto the current collector (S20); and
drying the electrode slurry and insulating composition applied onto the current collector (S30).

In addition, the electrode slurry and the insulating composition include the same or same type of a non-aqueous organic solvent.

Since the method of manufacturing an electrode for a secondary battery according to the present disclosure uses the same solvent in the electrode slurry and the insulating composition, the gelation of different types of binders, which may occur when the electrode slurry and the insulating composition are simultaneously applied, can be prevented, and accordingly, electrode productivity can be increased. Also, an insulating layer can provide excellent wet adhesion by including an aqueous binder.

In an embodiment, the method of manufacturing an electrode for a secondary battery according to the present disclosure may satisfy the following Expression 1.

$$0 \leq T 2 - T 1 \leq 100 ( sec ) \qquad [ Expression 1 ]$$

In Expression 1,

T1 refers to the time (sec) at which an electrode slurry is discharged onto a current collector from a slot-die coater in the application of an electrode slurry, and

T2 refers to the time (sec) at which an insulating composition is discharged onto a current collector from a slot-die coater in the application of an insulating composition.

For example, Expression 1 satisfies a range of 0.001 to 100 (sec), a range of 50 (sec) or less, or a range of 0.01 to 10 (sec).

Satisfaction of Expression 1 may mean that an insulating composition is applied in a state in which the electrode slurry applied onto the current collector is not dried. The state in which the electrode slurry is not dried means a state before an electrode drying process is performed after the application of the electrode slurry. In an aspect of the present disclosure, a simultaneous coating method, in which the application of an electrode slurry and the application of an insulating composition are substantially simultaneously performed, may be used to extremely increase productivity.

For example, the application of an electrode slurry and the application of an insulating composition are performed using a single die coater including two slots.

As another example, the application of an electrode slurry and the application of an insulating composition are performed using two separate die coaters.

The non-aqueous organic solvent included in the electrode slurry and insulating composition may be one or more selected from the group consisting of N-methyl-pyrrolidone (NMP), dimethyl formamide (DMF) and dimethyl acetamide (DMAc), dimethyl sulfoxide (DMSO), ethylene carbonate (EC), diethyl carbonate (DEC), ethyl methyl carbonate (EMC), dimethyl carbonate (DMC), propylene carbonate (PC), dipropyl carbonate (DPC), butylene carbonate (BC), methyl propyl carbonate (MPC), ethyl propyl carbonate (EPC), acetonitrile, dimethoxyethane, tetrahydrofuran (THF), γ-butyrolactone, methyl alcohol, ethyl alcohol, and isopropyl alcohol.

The non-aqueous organic solvent may be one or more selected from the group consisting of NMP, DMF, DMAc, and DMSO.

For example, the non-aqueous organic solvent may be an amide-based organic solvent, and the same solvent as a solvent used in preparation of the electrode slurry may be used. The non-aqueous organic solvent may be NMP.

When NMP is used as a solvent of the electrode slurry, a solvent of the insulating composition may also be NMP. Particularly, when NMP is used as a solvent of the insulating composition, the occurrence of cracking at the boundary between an insulating layer and an electrode mixture layer in the overlay region of an electrode may be prevented.

In addition, the insulating composition may further include inorganic particles. When inorganic particles are added in the insulating composition, it is possible to increase an electrical insulation property and minimize heat shrinkage.

For example, the inorganic particles are one or more selected from the group consisting of AlOOH, Al₂O₃, γ-AlOOH, Al(OH)₃, Mg(OH)₂, Ti(OH)₄, MgO, CaO, Cr₂O₃, MnO₂, Fe₂O₃, Co₃O₄, NiO, ZrO₂, BaTiO₃, SnO₂, CeO₂, Y₂O₃, SiO₂, silicon carbide (SIC), and boron nitride (BN).

In addition, a weight ratio of the inorganic particle and aqueous binder in the insulating composition ranges from 1:99 to 95:5. Specifically, the weight ratio of the inorganic particle and the aqueous binder ranges from 10:90 to 90:10, 40:60 to 90:10, 45:55 to 95:15, 45:55 to 90:10, or 50:50 to 90:10. By controlling the content range of inorganic particles, both wet adhesion and thermal stability may be increased.

The non-aqueous binder is one or more selected from the group consisting of polyvinylidene fluoride (PVDF), polyvinylidene fluoride-co-hexafluoropropylene (PVDF-co-HFP), polyethylene oxide (PEO), polyacrylic acid (PAA), polyimide (PI), polyamideimide (PAI), and a polyimide-polyamideimide copolymer (PI-PAI).

In addition, the aqueous binder may be one or more selected from the group consisting of styrene-butadiene rubber, acrylate styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene-propylene copolymer, polyethylene oxide, polyvinylpyrrolidone, polyepichlorohydrin, polyphosphazene, polyacrylonitrile, polystyrene, an ethylene-propylene-diene copolymer, polyvinylpyridine, chlorosulphonated polyethylene, latex, polyester resin, an acrylic resin, phenolic resin, an epoxy resin, polyvinyl alcohol, hydroxypropyl methylcellulose, hydroxypropyl cellulose, and diacetyl cellulose.

The insulating composition of the present disclosure may include: an aqueous binder dispersed in a non-aqueous solvent; and inorganic particles dispersed in the aqueous binder matrix dispersed in a non-aqueous solvent. For example, a weight ratio of the inorganic particle and the aqueous binder ranges from 1:99 to 95:5, and a viscosity at 25° C. ranges from 50 cP to 50,000 cP.

For example, the non-aqueous organic solvent is NMP, and the aqueous binder is styrene-butadiene rubber (SBR).

The drying of the electrode slurry and insulating composition applied onto the current collector may be performed at an average temperature of 50° C. to 300° C.

The method of manufacturing an electrode for a secondary battery according to the present disclosure will be described below in further detail.

(1) Application of Electrode Slurry onto One Surface or Both Surfaces of Current Collector (S10)

The method of manufacturing an electrode for a secondary battery according to the present disclosure includes applying an electrode slurry onto one surface or both surfaces of a current collector.

As the current collector, any current collector that does not cause a chemical change in a battery and has high conductivity may be used. For example, stainless steel, aluminum, nickel, titanium, calcined carbon, or the like may be used, and aluminum or stainless steel whose surface has been treated with carbon, nickel, titanium, silver, or the like may also be used. For example, the current collector may be aluminum.

In addition, as the positive electrode active material in the electrode slurry, any positive electrode active material that is typically used in a positive electrode may be used, and a lithium manganese oxide, a lithium cobalt oxide, a lithium nickel oxide, a lithium iron oxide, or a lithium composite oxide made by combining them may be used, but the present disclosure is not limited thereto.

The non-aqueous binder included in the electrode slurry may include one or more resins selected from the group consisting of a polyvinylidene fluoride-hexafluoropropylene copolymer (PVDF-co-HFP), polyvinylidene fluoride, polyacrylonitrile, polymethyl methacrylate, and a copolymer thereof. As an example, the binder may include polyvinylidene fluoride.

In addition, the conductive material may be used to enhance the performance, such as electrical conductivity, of the positive electrode, and one or more selected from the group consisting of natural graphite, artificial graphite, carbon black, acetylene black, Ketjen black, and carbon fiber may be used. For example, the conductive material may include acetylene black.

Furthermore, the solvent used in the positive electrode slurry is a non-aqueous organic solvent, and the non-aqueous organic solvent may be one or more selected from the group consisting of N-methyl-pyrrolidone (NMP), dimethyl formamide (DMF) and dimethyl acetamide (DMAc), dimethyl sulfoxide (DMSO), ethylene carbonate (EC), diethyl carbonate (DEC), ethyl methyl carbonate (EMC), dimethyl carbonate (DMC), propylene carbonate (PC), dipropyl carbonate (DPC), butylene carbonate (BC), methyl propyl carbonate (MPC), ethyl propyl carbonate (EPC), acetonitrile, dimethoxyethane, tetrahydrofuran (THF), γ-butyrolactone, methyl alcohol, ethyl alcohol, and isopropyl alcohol and may be, for example, NMP.

(2) Application of Insulating Composition so that Insulating Composition Covers from a Portion of Non-Coated Part of Current Collector to a Portion of Positive Electrode Slurry Applied onto Current Collector (S20)

The method of manufacturing an electrode for a secondary battery according to the present disclosure includes applying an insulating composition including an aqueous binder dispersed in a non-aqueous solvent so that the insulating composition covers from a portion of the non-coated part of the current collector to a portion of the positive electrode slurry applied onto the current collector. Specifically, the insulating composition may be applied to the boundary line between the non-coated part and coated part of an electrode.

In this case, the positive electrode slurry may be in an undried state. Here, the undried slurry may refer to a slurry not having undergone a separate drying process in a drying apparatus or equipment.

As described above, the insulating composition may be applied simultaneously with the positive electrode slurry onto a current collector.

The insulating composition may include an aqueous binder. The aqueous binder may be one or more selected from the group consisting of styrene-butadiene rubber, acrylate styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene-propylene copolymer, polyethylene oxide, polyvinylpyrrolidone, polyepichlorohydrin, polyphosphazene, polyacrylonitrile, polystyrene, an ethylene-propylene-diene copolymer, polyvinylpyridine, chlorosulphonated polyethylene, latex, polyester resin, an acrylic resin, phenolic resin, an epoxy resin, polyvinyl alcohol, hydroxypropyl methylcellulose, hydroxypropyl cellulose, and diacetyl cellulose.

Conventionally, polyvinylidene fluoride (hereinafter, referred to as PVDF), which is a non-aqueous binder, was used in an insulating layer of a positive electrode. However, when immersed in a liquid electrolyte of a secondary battery, the insulating layer exhibits degraded wet adhesion and thus is swelled or detached. On the other hand, when an aqueous binder is used in an insulating layer, a dense film is formed, and thus the insulating layer may exhibit enhanced wet adhesion. For example, styrene-butadiene rubber (SBR) may be used as the aqueous binder. Also, N-methyl-pyrrolidone, which may be a solvent used in the formation of a positive electrode mixture layer, may also be used as a dispersion solvent in the formation of the insulating layer. When SBR is used as the aqueous binder, water may be used as a solvent. However, when an insulating composition and a positive electrode slurry are simultaneously applied, the gelation of PVDF, which is an organic binder used as a binder of a positive electrode, between the insulating composition and the positive electrode slurry may occur. As a result, cracks may be generated at the boundary between the insulating composition and the positive electrode slurry.

In addition, the insulating composition may further include inorganic particles. In a specific embodiment, the inorganic particles may be one or more selected from the group consisting of AlOOH, Al₂O₃, γ-AlOOH, Al(OH)₃, Mg(OH)₂, Ti(OH)₄, MgO, CaO, Cr₂O₃, MnO₂, Fe₂O₃, Co₃O₄, NiO, ZrO₂, BaTiO₃, SnO₂, CeO₂, Y₂O₃, SiO₂, silicon carbide (SIC), and boron nitride (BN), specifically, one or more selected from the group consisting of AlOOH, Al₂O₃, γ-AlOOH, and Al(OH)₃. For example, the inorganic particles may be AlOOH. The inorganic particles may have an average particle diameter of 0.1 μm to 100 μm, specifically 0.5 μm to 80 μm, and more specifically 1 μm to 50 μm, 2 μm to 30 μm, 3 μm to 20 μm, or 5 μm to 10 μm. When the size of the inorganic particles falls within the above-described range, the inorganic particles can be uniformly applied in an electrode, and the resistance of lithium ions can be minimized to ensure the performance of a lithium secondary battery.

A weight ratio of the inorganic particle and the aqueous binder may range from 1:99 to 95:5, specifically 10:90 to 90:10, 40:60 to 90:10, 45:55 to 95:15, 45:55 to 65:35, or 65:35 to 85:15. When the amount of the aqueous binder is excessively small, it may be difficult to obtain an insulating effect desired in the present disclosure, and adhesion with an electrode may be degraded. On the other hand, when the amount of the aqueous binder is excessively large, the insulating composition drips in an overlay region in coating of an electrode, and thus the safety of a battery cell may be degraded.

In addition, the insulating composition according to the present disclosure may include the inorganic particles and the aqueous binder in an amount of 1 to 50 parts by weight, 5 to 40 parts by weight, or 10 to 40 parts by weight with respect to 100 parts by weight of the solvent.

Additionally, the insulating composition may have a viscosity at 25° C. of 50 cP to 50,000 cP, 100 cP to 45,000 cP, 1,000 cP to 40,000 cP, 2,000 cP to 35,000 cP, 3,000 cP to 30,000 cP, 4,000 cP to 20,000 cP, or 5,000 cP to 10,000 cP. Within the above-described range, wet adhesion can be increased, and coatability, processability, and the like can be enhanced.

Furthermore, the solvent used in the insulating composition is a non-aqueous organic solvent, and the non-aqueous organic solvent may be one or more selected from the group consisting of N-methyl-pyrrolidone (NMP), dimethyl formamide (DMF) and dimethyl acetamide (DMAc), dimethyl sulfoxide (DMSO), ethylene carbonate (EC), diethyl carbonate (DEC), ethyl methyl carbonate (EMC), dimethyl carbonate (DMC), propylene carbonate (PC), dipropyl carbonate (DPC), butylene carbonate (BC), methyl propyl carbonate (MPC), ethyl propyl carbonate (EPC), acetonitrile, dimethoxyethane, tetrahydrofuran (THF), γ-butyrolactone, methyl alcohol, ethyl alcohol, and isopropyl alcohol.

The non-aqueous organic solvent may be one or more selected from the group consisting of NMP, DMF, DMAc, and DMSO, specifically, one or more selected from the group consisting of NMP, DMF, and DMAc.

For example, the non-aqueous organic solvent may be an amide-based organic solvent, and the same solvent as a solvent used in preparation of the positive electrode slurry may be used. The non-aqueous organic solvent may be NMP.

As described above, in the insulating composition, the same non-aqueous organic solvent as in the positive electrode slurry may be used. When the same solvent is used in the positive electrode slurry and the insulating composition, gelation caused by using different types of binders or cracking caused by a difference in boiling point during a drying process can be prevented.

The application of an insulating composition onto the current collector may be performed in a state in which the positive electrode slurry is not dried, or the positive electrode slurry and the insulating composition may be simultaneously applied.

(3) Drying of Positive Electrode Slurry and Insulating Composition Applied onto Current Collector (S30)

The method of manufacturing an electrode for a secondary battery according to the present disclosure includes drying the positive electrode slurry and insulating composition applied onto the current collector. The drying of the positive electrode slurry and insulating composition applied onto the current collector may be performed at an average temperature of 50° C. to 300° C.

In the drying of the positive electrode slurry and insulating composition, the positive electrode slurry and the insulating composition may be completely dried by a drying method typically known in the art to remove moisture. The drying may be performed by varying a hot air method, a direct heating method, an induction heating method, and the like at an enough temperature to completely evaporate moisture, but the present disclosure is not limited thereto. For example, the drying of the insulating coating liquid may be performed by a hot air method.

In this case, the drying temperature may range from 50° C. to 300° C., specifically, 60° C. to 200° C. or 70° C. to 150° C. Meanwhile, when the drying temperature of the insulating coating liquid is less than 50° C., it may be difficult to completely dry the insulating coating liquid due to an excessively low temperature, and when the drying temperature exceeds 300° C., an electrode or a separator may be deformed due to an excessively high temperature.

A positive electrode for a lithium secondary battery may be manufactured by forming a positive electrode mixture layer and an insulating layer on a current collector and roll-pressing the current collector.

### Insulating Composition for Electrode of Secondary Battery

The present disclosure also provides an insulating composition for an electrode of a secondary battery. The insulating composition according to the present disclosure may include: a non-aqueous organic solvent; and inorganic particles and an aqueous binder dispersed in the non-aqueous organic solvent. Also, the insulating composition includes the inorganic particles and the aqueous binder in a weight ratio of 1:99 to 95:5 and has a viscosity at 25° C. of 50 cP to 50,000 cP.

The insulating composition for an electrode of a secondary battery according to the present disclosure has an advantage in that the migration of lithium ions in the overlay region of an electrode can be blocked to suppress capacity expression and the like due to having excellent wet adhesion in a liquid electrolyte.

For this reason, the present disclosure provides an insulating composition for an electrode, in which inorganic particles and an aqueous binder are dispersed in a non-aqueous organic solvent. Generally, an electrode in a secondary battery is present in an immersed state in a liquid electrolyte, and accordingly, a conventional insulating layer exhibits degraded wet adhesion while being immersed in a liquid electrolyte and does not block the migration of lithium ions in the overlay region of the electrode to cause capacity expression. Particularly, when capacity is expressed in the overlay region of the electrode, lithium ions may be precipitated, which may cause the stability of a battery cell to be degraded. In the present disclosure, an insulating composition for an electrode, in which inorganic particles and an aqueous binder are dispersed in a non-aqueous organic solvent used as a solvent of an electrode slurry, can be provided to enhance wet adhesion in a liquid electrolyte. That is, when applied to an electrode, the insulating composition enhances wet adhesion, and thus the migration of lithium ions in the overlay region of the electrode can be suppressed, and lithium ions can be prevented from being precipitated. Therefore, when applied to an electrode of a secondary battery, the insulating composition can enhance the stability of the secondary battery.

The insulating composition for an electrode according to the present disclosure may include inorganic particles and an aqueous binder which are dispersed in a non-aqueous organic solvent in a ratio of 1:99 to 95:5. When the insulating composition for an electrode is used as an insulating layer, wet adhesion can be excellent.

The wet adhesion of the insulating layer may be measured by immersing a metal specimen including an insulating layer formed therein in a liquid electrolyte, applying ultrasonic waves, and then determining whether the insulating layer formed in the metal specimen is swelled or detached.

The liquid electrolyte used in the measurement of wet adhesion may include an organic solvent and an electrolyte salt, and the electrolyte salt may be a lithium salt. As the lithium salt, any lithium salt that is typically used in a non-aqueous liquid electrolyte for a lithium secondary battery may be used without limitation. For example, an anion of the lithium salt may include any one or two or more selected from the group consisting of F⁻, Cl⁻, Br, I, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, CF₃(CF₂)₇SO₃⁻, CF₃CO₂⁻, CH₃CO₂⁻, SCN⁻, and (CF₃CF₂SO₂)₂N⁻.

As the above-described organic solvent included in the liquid electrolyte, any organic solvent that is typically used in a liquid electrolyte for a lithium secondary battery may be used without limitation. For example, an ether, an ester, an amide, a linear carbonate, a cyclic carbonate, or the like may be used alone or in combination of two or more thereof. Among them, a cyclic carbonate, a linear carbonate, or a carbonate compound which is a mixture thereof may be typically used.

In addition, the insulating composition for an electrode of a secondary battery according to the present disclosure may be applied to a positive electrode, and the non-aqueous organic solvent may be one or more selected from the group consisting of N-methyl-pyrrolidone (NMP), dimethyl formamide (DMF) and dimethyl acetamide (DMAc), dimethyl sulfoxide (DMSO), ethylene carbonate (EC), diethyl carbonate (DEC), ethyl methyl carbonate (EMC), dimethyl carbonate (DMC), propylene carbonate (PC), dipropyl carbonate (DPC), butylene carbonate (BC), methyl propyl carbonate (MPC), ethyl propyl carbonate (EPC), acetonitrile, dimethoxyethane, tetrahydrofuran (THF), γ-butyrolactone, methyl alcohol, ethyl alcohol, and isopropyl alcohol.

The non-aqueous organic solvent may be one or more selected from the group consisting of NMP, DMF, DMAc, and DMSO. For example, the non-aqueous organic solvent may be one or more selected from the group consisting of NMP, DMF, and DMAc.

For example, the non-aqueous organic solvent may be an amide-based organic solvent, and the same solvent as a solvent used in preparation of a positive electrode slurry may be used. The non-aqueous organic solvent may be NMP.

When used as an insulating coating liquid of a positive electrode, the insulating composition according to the present disclosure may be applied and dried simultaneously with the positive electrode mixture layer. When the same solvent as a solvent of the positive electrode slurry is used as a solvent of the insulating composition, a difference in a drying rate and the like is reduced, and thus cracking and the like that occur at the boundary between the insulating coating layer and the positive electrode mixture layer may be prevented. For example, the NMP solvent may be used as a dispersion solvent, and the aqueous binder may be present as an NMP-dispersed binder.

In addition, the aqueous binder may be one or more selected from the group consisting of styrene-butadiene rubber, acrylate styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene-propylene copolymer, polyethylene oxide, polyvinylpyrrolidone, polyepichlorohydrin, polyphosphazene, polyacrylonitrile, polystyrene, an ethylene-propylene-diene copolymer, polyvinylpyridine, chlorosulphonated polyethylene, latex, polyester resin, an acrylic resin, phenolic resin, an epoxy resin, polyvinyl alcohol, hydroxypropyl methylcellulose, hydroxypropyl cellulose, and diacetyl cellulose. In a specific embodiment, the aqueous binder may be one or more selected from the group consisting of styrene-butadiene rubber, acrylate styrene-butadiene rubber, acrylonitrile-butadiene rubber, and acrylonitrile-butadiene-styrene rubber. For example, the aqueous binder may be styrene-butadiene rubber.

Additionally, the insulating composition can enhance the safety of a battery by including inorganic particles, and the strength of the insulating layer can also be enhanced. The amount of the inorganic particles may be appropriately adjusted in consideration of the viscosity of an insulating composition, thermal resistance, an insulating property, a filling effect, dispersibility, stability, or the like. Generally, as the size of inorganic particles increases, the viscosity of a composition including the same increases, and the possibility of sedimentation in an insulating composition increases. Also, as the size of the inorganic particles decreases, thermal resistance increases. Therefore, considering the above points, an appropriate type and size of inorganic particles may be selected, and if necessary, at least two types of inorganic particles may be used.

The inorganic particles may be one or more selected from the group consisting of AlOOH, Al₂O₃, γ-AlOOH, Al(OH)₃, Mg(OH)₂, Ti(OH)₄, MgO, CaO, Cr₂O₃, MnO₂, Fe₂O₃, Co₃O₄, NiO, ZrO₂, BaTiO₃, SnO₂, CeO₂, Y₂O₃, SiO₂, silicon carbide (SIC), and boron nitride (BN), specifically, one or more selected from the group consisting of AlOOH, Al₂O₃, γ-AlOOH, and Al(OH)₃. For example, the inorganic particles may be AlOOH.

A weight ratio of the inorganic particle and the aqueous binder may range from 1:99 to 95:5, 10:90 to 70:30, 20:80 to 60:40, or 40:60 to 60:40. For example, a weight ratio of the inorganic particle and aqueous binder in the insulating composition may be 50:50. Meanwhile, when the amount of the aqueous binder is excessively small, it may be difficult to obtain an insulating effect desired in the present disclosure, and adhesion with an electrode may be degraded. On the other hand, when the amount of the aqueous binder is excessively large, the insulating composition drips in an overlay region in coating of an electrode, and thus the safety of a battery cell may be degraded.

The inorganic particles may have an average particle diameter of 0.01 μm to 100 μm, specifically, 0.5μ m to 80 μm, 1 μm to 50 μm, 2 μm to 30 μm, 3 μm to 20 μm, or 5μ m to 10 μm. When the size of inorganic particles falls within the above-described range, the inorganic particles can be uniformly applied in the electrode, and the resistance of lithium ions can be minimized to ensure the performance of a lithium secondary battery.

In another embodiment, the insulating composition may include first and second inorganic particles having mutually different particle diameters and may have a bimodal particle size distribution. This means that the inorganic particles are composed of a mixture of small-sized particles and large-sized particles, and small-sized second inorganic particles may fill the empty space between large-sized first inorganic particles, and an appropriate amount of inorganic particles may be dispersed. However, the present disclosure is not limited thereto.

Meanwhile, the insulating composition for an electrode according to the present disclosure includes inorganic particles and SBR in an amount of 1 to 50 parts by weight, 5 to 40 parts by weight, or 10 to 40 parts by weight with respect to 100 parts by weight of the NMP solvent.

The insulating composition may have a viscosity at 25° C. of 50 cP to 50,000 cP, 100 cP to 45,000 cP, 1,000 cP to 40,000 cP, 2,000 cP to 35,000 cP, 3,000 cP to 30,000 cP, 4,000 cP to 20,000 cP, or 5,000 cP to 10,000 cP, and within the above-described range, adhesion with an electrode mixture layer can be enhanced, and coatability, processability, and the like can be enhanced.

Hereinafter, the present disclosure will be described in further detail with reference to examples and experimental examples.

However, it should be understood that the following examples and experimental examples are given for the purpose of illustration only and are not intended to limit the scope of the present disclosure.

### Example 1

To 100 g of a styrene-butadiene rubber (hereinafter, referred to as SBR, BM451B commercially available from ZEON Chemicals) binder dispersed in water as a solvent in a ratio of 60:40 (parts by weight), 500 g of an N-methyl-2-pyrrolidone (NMP) solvent was added and stirred. Then, the stirred mixture was heated at 100 to 120° C. for 2 hours to completely evaporate water contained therein to prepare an NMP-dispersed SBR binder. Then, the NMP-dispersed SBR binder and inorganic particles were mixed in a weight ratio of 50:50 and stirred to prepare an insulating composition. The prepared insulating composition had a viscosity of 5,000 cP.

### Examples 2 to 4 and Comparative Examples 1 to 3

An insulating composition was obtained in the same manner as in Example 1, except that the amounts of inorganic particles and a binder are changed in the preparation of an insulating composition.

Specific compositions of Examples 1 to 4 and Comparative Examples 1 to 3 are shown in the following Table 1.

TABLE 1

| | Insulating composition | | | |
|---|---|---|---|---|
| | | Inorganic | | Inorganic particle:Binder |
| Classification | Solvent | particle | Binder | (weight ratio) |
| Example 1 | NMP | AlOOH | SBR | 50:50 |
| Example 2 | NMP | AlOOH | SBR | 60:40 |
| Example 3 | NMP | AlOOH | SBR | 75:25 |
| Example 4 | NMP | AlOOH | SBR | 80:20 |
| Comparative | Water | AlOOH | SBR | 50:50 |
| Example 1 | | | | |
| Comparative | NMP | AlOOH | PVDF | 80:20 |
| Example 2 | | | | |
| Comparative | NMP | AlOOH | PVDF | 88:12 |
| Example 3 | | | | |

### Experimental Example 1. Simultaneous Application of Positive Electrode Slurry and Insulating Composition

96 parts by weight of LiNi_{0.8}Co_{0.1}Mn_{0.1}O₂ as a positive electrode active material, 2 parts by weight of PVdF as a binder, and 2 parts by weight of carbon black as a conductive material were weighed and mixed in an N-methyl-pyrrolidone (NMP) solvent to prepare a positive electrode slurry.

The positive electrode slurry and the insulating composition prepared in Example 1 or Comparative Example 1 were simultaneously applied onto a current collector using a double slot-die coater. Then, each electrode sample was dried at an average temperature of 60° C.

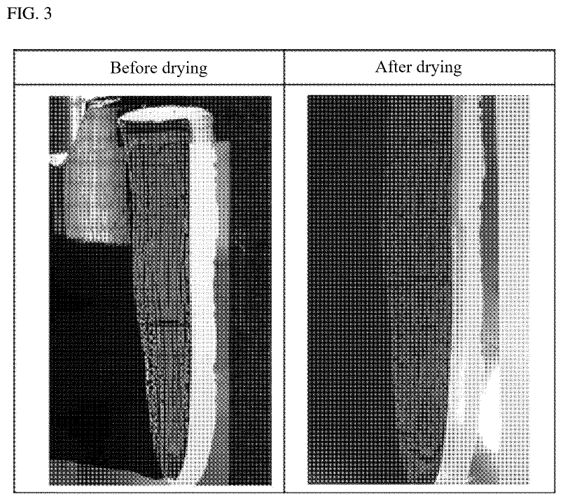

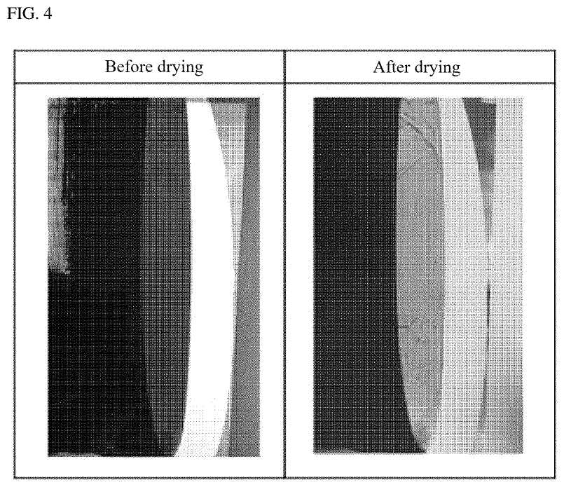

Results thereof are shown in FIGS. 3 and 4. FIG. 3 is a photographic image showing results before and after drying when the positive electrode slurry and the insulating composition prepared in Comparative Example 1 were simultaneously applied, and FIG. 4 is a photographic image showing results before and after drying when the positive electrode slurry and the insulating composition prepared in Example 1 were simultaneously applied.

As shown in the figures, referring to FIG. 3, the insulating composition of Comparative Example 1 showed gelation due to phase separation from the binder of the positive electrode slurry in the overlay region of the positive electrode mixture layer. On the other hand, referring to FIG. 4, the insulating composition of Example 1 did not show phase separation from the binder of the positive electrode slurry.

### Experimental Example 2. Measurement of Wet Adhesion of Insulating Layer

In order to evaluate the adhesion of an insulating layer according to the present disclosure, an experiment was performed as follows.

### Metal Specimen Including Insulating Layer Formed Therein

Each of the insulating compositions prepared in Examples 1 to 4 and Comparative Examples 2 and 3 was applied onto an aluminum metal foil and dried to prepare a metal specimen in which an about 10 μm-thick insulating layer was formed. The metal specimen including the insulating layer formed therein was blanked to a size of 2 cm×2 cm using a blanking device for adhesion measurement.

Application of ultrasonic waves 200 g of a liquid electrolyte (EC/EMC=3/7 (vol %)) was input into a 250 ml beaker, and the metal specimen including the insulating layer formed therein was immersed in the liquid electrolyte. In order to control the movement of the metal specimen, the metal specimen was immobilized with a jig.

Then, ultrasonic waves were applied to the liquid electrolyte in which the metal specimen was immersed using a sonicator (4200 commercially available from BANDELIN).

In this case, conditions for applying ultrasonic waves were as follows.
Frequency: 20 kHz
Tip diameter: 13 mm (TS-113)
Amplitude: 100%
(in use of 13 mm tip, peak-to-peak 132 μm)

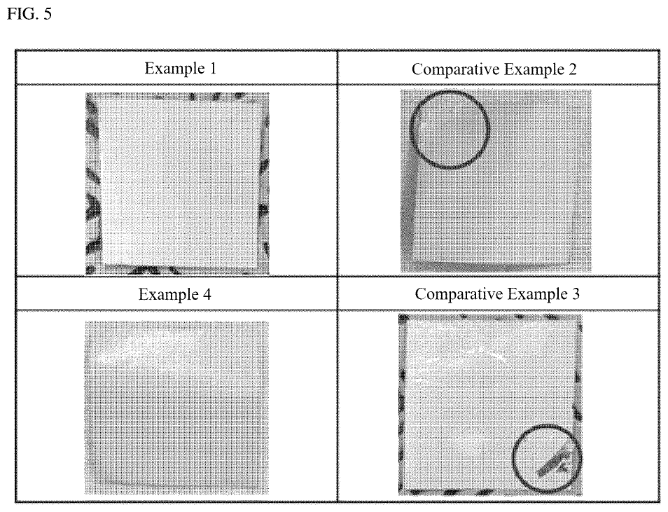

Results thereof are shown in the following Table 2 and FIG. 5.

TABLE 2

| | | | | | Comparative | Comparative |
|---|---|---|---|---|---|---|
| Classification | Example 1 | Example 2 | Example 3 | Example 4 | Example 2 | Example 3 |
| Composition | AlOOH:SBR = | AlOOH:SBR = | AlOOH:SBR = | AlOOH:SBR = | AlOOH:PVDF = | AlOOH:PVDF = |
| | 50:50 | 60:40 | 75:25 | 80:20 | 80:20 | 88:12 |
| Time (mins) | 19 | 19 | 19 | 15 | 5 | 10 |
| Termination | 109 | 109 | 109 | 100 | 71 | 87 |
| temperature | | | | | | |
| (° C.) | | | | | | |
| Comparison | no swelling | no swelling | no swelling | no swelling | swelling | swelling and |
| of wet | and no | and no | and no | and no | | detachment |
| adhesion | detachment | detachment | detachment | detachment | | |

FIG. 5 is a diagram showing results of measuring the wet adhesion of insulating layers of Examples 1 and 4 and Comparative Examples 2 and 3. Referring to Table 2 and FIG. 5, the electrode specimen of Example 1 did not show swelling or detachment of the insulating layer. However, in the case of Example 1, when 109° C. was reached, measurement was stopped as a measurement environment was changed by evaporating a solvent due to an increase in the temperature of a liquid electrolyte due to application of ultrasonic waves and the EMC boiling point of 107.5° C.

Although not shown in the figure, like Example 1, the electrode specimens of Examples 2 and 3 did also not show swelling or detachment of the insulating layer. However, when 109° C. was reached, measurement was stopped as a measurement environment was changed by evaporating the solvent due to the EMC boiling point of 107.5° C.

In the case of Example 4, swelling or detachment did not occur in the electrode specimen during 15 minutes of application of ultrasonic waves to a liquid electrolyte. However, although not shown in the figure, when 108° C. was reached as the temperature of a liquid electrolyte was increased due to continuous application of ultrasonic waves, swelling and detachment in the electrode specimen occurred.

In addition, in the case of Comparative Examples 2 and 3, swelling and detachment in the electrode specimen occurred in just 5 minutes of application of ultrasonic waves to a liquid electrolyte.

From the above results, it could be confirmed that the insulating layers of Examples had excellent wet adhesion compared to the insulating layers of Comparative Examples 1 and 2.

### Experimental Example 3. Evaluation of Capacity Expression of Battery Cell

In order to evaluate the performance of the positive electrode including an insulating layer according to the present disclosure, a half-cell was fabricated, and then capacity expression was evaluated.

### Fabrication of Half-Cell

96 parts by weight of LiNi_{0.8}Co_{0.1}Mn_{0.1}O₂ as a positive electrode active material, 2 parts by weight of polyvinylidene fluoride (PVDF) as a binder, and 2 parts by weight of carbon black as a conductive material were weighed and mixed in an N-methylpyrrolidone (NMP) solvent to prepare a positive electrode slurry. Then, the positive electrode slurry was applied onto an aluminum foil, dried, and roll-pressed to manufacture a positive electrode including a positive electrode mixture layer (average thickness: 130 μm).

Then, the positive electrode was dip-coated with each insulating coating liquid obtained in Examples 1 to 3 and then dried in a convection oven (130° C.) to form a 10 μm-thick insulating layer in the positive electrode. A lithium foil as a negative electrode and a liquid electrolyte in which 1 M LiPF₆ was added in a solvent (EC:DMC:DEC=1:2:1) were used to fabricate a coin-type half-cell.

TABLE 3

| Insulating layer | Battery |
|---|---|
| Example 1 | Example 5 |
| Example 2 | Example 6 |
| Example 3 | Example 7 |

### Measurement of Discharge Capacity

The discharge characteristics of the batteries of Examples 5 to 7 were evaluated under the following conditions. Also, the discharge characteristics were measured each at room temperature (25° C.) and high temperature (45° C.).
Discharge: 0.1 C, 0.33 C, 0.5 C, 1.0 C, 2.5, cut-off

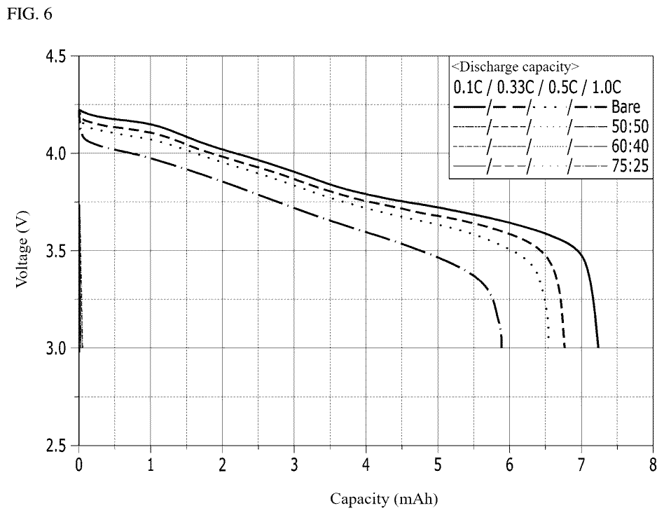

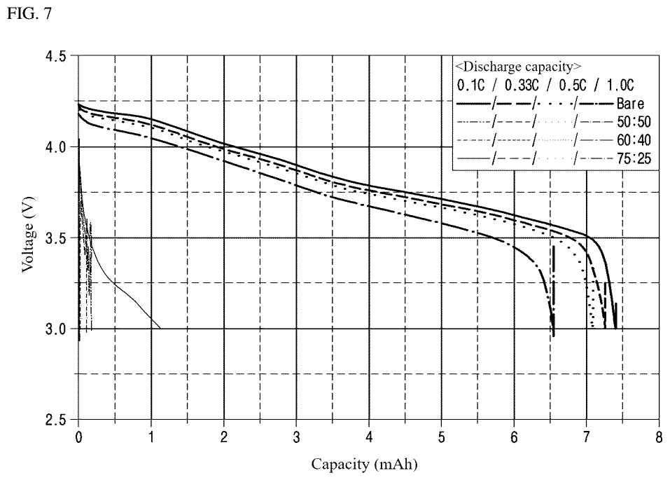

Meanwhile, to compare the capacity expression of each battery, a battery cell including an electrode including no insulating layer was used as Comparative Example 4. Results thereof are shown in Tables 4 and 5 and FIGS. 6 and 7.

TABLE 4

| | Insulating composition | | | | | | | |
|---|---|---|---|---|---|---|---|---|
| | | | | Inorganic | | | | |
| | | Inorganic | | particle:Binder | Room-temperature discharge rate (%) | | | |
| Classification | Solvent | particle | Binder | (weight ratio) | 0.1 C | 0.33 C | 0.5 C | 1.0 C |
| Comparative | — | — | — | — | 100.00 | 100.00 | 100.00 | 100.00 |
| Example 4 | | | | | | | | |
| Example 5 | NMP | AlOOH | SBR | 50:50 | 0.33 | 0.06 | 0.05 | 0.00 |
| Example 6 | NMP | AlOOH | SBR | 60:40 | 0.60 | 0.09 | 0.05 | 0.03 |
| Example 7 | NMP | AlOOH | SBR | 75:25 | 0.27 | 0.06 | 0.03 | 0.00 |

TABLE 5

| | Insulating composition | | | | | | | |
|---|---|---|---|---|---|---|---|---|
| | | | | Inorganic | | | | |
| | | Inorganic | | particle:Binder | High-temperature discharge rate (%) | | | |
| Classification | Solvent | particle | Binder | (weight ratio) | 0.1 C | 0.33 C | 0.5 C | 1.0 C |
| Comparative | — | — | — | — | 100.00 | 100.00 | 100.00 | 100.00 |
| Example 4 | | | | | | | | |
| Example 5 | NMP | AlOOH | SBR | 50:50 | 2.23 | 0.21 | 0.15 | 0.05 |
| Example 6 | NMP | AlOOH | SBR | 60:40 | 1.41 | 0.18 | 0.15 | 0.03 |
| Example 7 | NMP | AlOOH | SBR | 75:25 | 15.35 | 0.18 | 0.15 | 0.03 |

Referring to Tables 4 and 5 and FIGS. 6 and 7, in the case of high-temperature discharging (45° C.), the battery of Example 7 partially expressed capacity when discharged at 0.1 C, whereas the batteries of Examples 5 and 6 hardly expressed capacity in the case of room-temperature discharging (25° C.).

The above result is considered to be due to the fact that the insulating layer prevents the migration of lithium ions in the overlay region of the electrode to suppress capacity expression and the like during discharging by having excellent wet adhesion in a liquid electrolyte. Accordingly, in the case of the lithium secondary battery according to the present disclosure, degradation of capacity according to a cycle increase can be suppressed, and safety can be improved.

While the present disclosure has been described above with reference to the examples, it can be understood by those skilled in the art that various modifications and alterations may be made without departing from the spirit and technical scope of the present disclosure described in the appended claims.

Therefore, the technical scope of the present disclosure should be defined by the appended claims and not limited by the detailed description of the specification.

1. A method of manufacturing an electrode for a secondary battery, comprising:
applying an electrode slurry including an electrode active material, a conductive material, and a non-aqueous binder, and a first non-aqueous organic solvent onto one surface or both surfaces of a current collector;
applying an insulating composition including an aqueous binder dispersed in a second non-aqueous solvent so that the insulating composition covers from a portion of the non-coated part of the current collector to a portion of the electrode slurry applied onto the current collector; and
drying the electrode slurry and insulating composition applied onto the current collector,
wherein the first non-aqueous organic solvent in the electrode slurry and the second non-aqueous organic solvent in the insulating composition are the same or same type of a non-aqueous organic solvent.

2. The method of claim 1, wherein the applying the electrode slurry and the applying
the insulating composition satisfy the following Expression 1:
$$0 \leq T 2 - T 1 \leq 100 ( sec ) \qquad [ Expression 1 ]$$
wherein,
T1 is time (sec) when the electrode slurry is discharged onto a current collector from a slot-die coater in the application of an electrode slurry, and
T2 is time (sec) when the insulating composition is discharged onto a current collector from a slot-die coater in the application of an insulating composition.

3. The method of claim 1, wherein the applying the insulating composition is performed when the electrode slurry applied onto the current collector is not dried.

4. The method of claim 1, wherein the non-aqueous organic solvent includes one or more of N-methyl-pyrrolidone (NMP), dimethyl formamide (DMF) and dimethyl acetamide (DMAc), dimethyl sulfoxide (DMSO), ethylene carbonate (EC), diethyl carbonate (DEC), ethyl methyl carbonate (EMC), dimethyl carbonate (DMC), propylene carbonate (PC), dipropyl carbonate (DPC), butylene carbonate (BC), methyl propyl carbonate (MPC), ethyl propyl carbonate (EPC), acetonitrile, dimethoxyethane, tetrahydrofuran (THF), γ-butyrolactone, methyl alcohol, ethyl alcohol, or isopropyl alcohol.

5. The method of claim 1, wherein the insulating composition further includes inorganic particles.

6. The method of claim 5, wherein the inorganic particles are one or more of AlOOH, Al₂O₃, γ-AlOOH, Al(OH)₃, Mg(OH)₂, Ti(OH)₄, MgO, CaO, Cr₂O₃, MnO₂, Fe₂O₃, Co₃O₄, NiO, ZrO₂, BaTiO₃, SnO₂, CeO₂, Y₂O₃, SiO₂, silicon carbide (SIC), or boron nitride (BN).

7. The method of claim 5, wherein a weight ratio of the inorganic particle to the aqueous binder in the insulating composition ranges from 1:99 to 95:5.

8. The method of claim 1, wherein the non-aqueous binder includes one or more of polyvinylidene fluoride (PVDF), polyvinylidene fluoride-co-hexafluoropropylene (PVDF-co-HFP), polyethylene oxide (PEO), polyacrylic acid (PAA), polyimide (PI), polyamideimide (PAI), or a polyimide-polyamideimide copolymer (PI-PAI).

9. The method of claim 1, wherein the aqueous binder includes one or more of styrene-butadiene rubber, acrylate styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene-propylene copolymer, polyethylene oxide, polyvinylpyrrolidone, polyepichlorohydrin, polyphosphazene, polyacrylonitrile, polystyrene, an ethylene-propylene-diene copolymer, polyvinylpyridine, chlorosulphonated polyethylene, latex, polyester resin, an acrylic resin, phenolic resin, an epoxy resin, polyvinyl alcohol, hydroxypropyl methylcellulose, hydroxypropyl cellulose, or diacetyl cellulose.

10. The method of claim 1, wherein the insulating composition includes: an aqueous binder dispersed in a non-aqueous solvent; and inorganic particles dispersed in the aqueous binder matrix dispersed in a non-aqueous solvent,
a weight ratio of the inorganic particle and the aqueous binder ranges from 1:99 to 95:5, and
a viscosity at 25° C. ranges from 50 cP to 50,000 cP.

11. The method of claim 1, wherein the non-aqueous organic solvent is N-methyl-pyrrolidone (NMP), and the aqueous binder is styrene-butadiene rubber (SBR).

12. The method of claim 1, wherein the drying the electrode slurry and the insulating composition applied onto the current collector is performed at an average temperature of 50° C. to 300° C.

13. The method of claim 1, wherein the applying the electrode slurry and the applying the insulating composition are performed using a single die coater including two slots.

14. The method of claim 1, wherein the applying the electrode slurry and the application of an insulating composition are performed using two separate die coaters.

15. An insulating layer for an electrode for a lithium secondary battery, comprising:
an aqueous binder,
wherein the insulation layer is configured so that when a 2 cm×2 cm metal specimen having the insulating layer of about 10 μm in thickness on an aluminum metal foil is immersed in a liquid electrolyte followed by application of ultrasonic waves to the liquid electrolyte to test for wet adhesion, the metal specimen does not show swelling or detachment of the insulating layer.

16. The insulating layer of claim 15, wherein the aqueous binder includes styrene butadiene rubber, acrylate styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene-propylene copolymer, polyethylene oxide, polyvinylpyrrolidone, polyepichlorohydrin, polyphosphazene, polyacrylonitrile, polystyrene, an ethylene-propylene-diene copolymer, polyvinylpyridine, chlorosulphonated polyethylene, latex, polyester resin, an acrylic resin, phenolic resin, an epoxy resin, polyvinyl alcohol, hydroxypropyl methylcellulose, hydroxypropyl cellulose, and diacetyl cellulose.

17. The insulating layer of claim 15, wherein the non-aqueous binder includes one or more of polyvinylidene fluoride (PVDF), polyvinylidene fluoride-co-hexafluoropropylene (PVDF-co-HFP), polyethylene oxide (PEO), polyacrylic acid (PAA), polyimide (PI), polyamideimide (PAI), or a polyimide-polyamideimide copolymer (PI-PAI).

18. The insulating layer of claim 15, wherein the aqueous binder is styrene butadiene rubber and the non-aqueous organic solvent is N-methyl-pyrrolidone (NMP).

19. The insulating layer of claim 15, further comprising an inorganic particle.
